(19) United States
(12) Patent Application Publication
(10) Pub. No.: US 2007/0150906 A1
(43) Pub. Date: Jun. 28, 2007

(54) Method for integration of functionality of computer programs and substitute user interface for transportation environment

(76) Inventors: Art Richards, Fallbrook, CA (US); Christopher M. Piedmont, Carmel, IN (US)

Correspondence Address: Phil Virga, Suite 105, 1525 Aviation Blvd., Redondo Beach, CA, 90278, US

(21) Appl. No.: 11/299,454

(22) Filed: Dec. 9, 2005

(51) Int. Cl. G06F 9/46

(52) U.S. Cl. 719/328

(57) ABSTRACT

A method is provided for integration of functionality of two or more computer programs and to provide an alternative user interface to these programs. The integration of the functionality of the programs is accomplished through a collection of software modules that homogenize the differences between the individual computer programs and provide a consistent API to the controlling portion of a computer program. Further, the collection of software modules also provides an alternative graphical user interface for each computer program.

### BACKGROUND

The present invention relates to the field of computer programs, and in particular, to the integration of computer program functionality for the purpose of causing the programs to appear to function as a single unified program, and to provide alternative appearance and operations of the programs through a substitute user interface for the purpose of improving the usability of the programs in a transportation environment.

Many computer software programs have been designed to provide for some integration of functionality between programs. In general, this is accomplished by the sharing of data between two or more programs through various means. These means may include the sharing of data files, the sharing of memory between programs, and the use of various operating system provided mechanisms, including remote procedure calls, clipboard (cut and paste) functionality, messaging, and network-based data protocols.

An early means of providing integration between programs was the reading and writing of data files which are created in a format that is known to, and contains information usable by, more than one program. A first program can then perform its function and save the results produced to a data file. A second program can then read this data file and then perform its function using some or all of the information contained in the data file.

Another means to provide integration through sharing of data is the use of areas of shared memory in the computer. To accomplish this integration, two programs are granted access to and manipulate data within the memory of the computer in such a way as to ensure that the data is usable by both programs.

To provide integration of functionality via remote procedure calls, a first program exposes an application programming interface (API) capable of receiving data from a second program and returning information to the second program. The second program can then call the API of the first program and provide data in a format that is known to both programs. The second program may also receive data from the first program which the first program returns to the second program when the first program completes the API call.

Clipboard based integration of functionality is accomplished in a manner identical to that of shared memory, however the computer operating system provides for the management and control of the area of shared memory. The clipboard consists of an area of memory managed by the operating system, an API to provide data to the clipboard, and an API to request data from the clipboard. The first program provides the data to the clipboard through an API in one or more formats supported by the operating system. A second program requests the data from the clipboard through an API and the operating system provides the data in one or more formats supported by the operating system.

Messaging is another means by which integration of programs through sharing of data can be accomplished. Like the clipboard, messaging is provided by the computer operating system through one or more APIs. Messaging is implemented by providing an API through which a first program can send a message to a second program. The format of the message is not dictated by the operating system, however the operating system provides a means for the first program through an API to specify the second program to receive the data through a unique identification mechanism specific to the operating system, as well as a means to provide additional data to indicate the nature of the data from the first program to the second program.

Network-based protocols for integration of functionality are also provided by the computer operating system. The computer operating system provides one or more APIs to allow for the sending and receiving of data. This integration is then accomplished by providing or requesting data from or to a named entity representing another program operating on the same or another computer.

Providing an alternative user interface is not a common practice in the industry, except for the area of providing accessibility to the information presented on the computer display to those that are visually impaired or blind, or to provide alternative means of keyboard and pointer input for those with physical impairments.

Several programs have been created to provide a means to enlarge the graphical and textual information on all or specific areas of the computer display for those that are visually impaired. These products include ZoomText Magnifier and MAGic Pro, which are two software products designed specifically for this purpose.

For the blind, programs have been developed that will provide audible information indicating the content and placement of the information presented on the computer display. The audible information is generally presented as spoken words. Software products that provide this functionality include Microsoft Speech™ by Microsoft Corporation, JAWS™ by Henter-Joyce, Incorporated, and Advision by Freedom Scientific, Incorporated.

Alternative input devices also have been created to allow disabled individuals to control and provide input to computer devices. These devices include various reduced functionality keyboards, switches located in proximity to the fingers, arms, and head of an individual, and more recently speech to text devices capable of interpreting sounds and providing data as a substitute for the standard keyboard and mouse to the computer system.

Therefore, there is a need to provide an alternative appearance and operations of the programs through a substitute user interface for the purpose of improving the usability of the programs in an automotive environment. Furthermore, there is a need for software developed by third parties to interact to perform useful functions without user intervention and the ability to present an alternative, consistent interface to the user without altering the third party software or writing a custom application.

### SUMMARY

A method is provided for integration of functionality of two or more computer programs and to provide an alternative user interface to these programs. The integration of the functionality of the programs is accomplished through a collection of software modules that homogenize the differences between the individual computer programs and provide a consistent API to the controlling portion of a computer program. Further, the collection of software modules also provides an alternative graphical user interface for each computer program.

It is a primary object that the alternative appearance of the computer programs be accomplished through the use of additional display devices, such as dedicated LCD or VCF displays, in place of the standard computer display video monitor or LCD panel.

It is a another primary object that the functionality of the computer programs be controlled by push buttons, levers, knobs and other physical controls instead of the standard computer input devices of keyboard and mouse.

### BRIEF DESCRIPTION OF THE DRAWINGS

The drawings are not to scale and are only for purposes of illustration.

FIG. 1 is a diagram illustrating the physical components of the preferred embodiment;

FIG. 2 is the appearance of the Graphical User Interface (GUI) of the Executive (EX) as presented on the user interface display;

FIG. 3 is a diagram showing the major programmatic modules of the system;

FIG. 4 is a diagram showing the flow of program execution that provides for functional integration based on an event; and

FIG. 5 is a diagram showing the flow of program execution that provides for functional integration based on a status change.

### DETAILED DESCRIPTION

With the advent of computer technology, the interior of an automobile dashboard, steering column and center console may include a standard PC-compatible computer system having a graphical user interface display (not shown). The standard PC-compatible computer system is designed for mobile or portable use and is mounted within the automobile or other transportation vehicle, with the graphical user interface displayed in a manner easily visible to the driver and/or passenger(s), who is/are the user(s) of the computer system. The computer system may be running Microsoft Windows XP or a newer operating system; however this is for illustration purposes only. Other computer systems and operating systems may be may be mounted and utilized within the automobile.

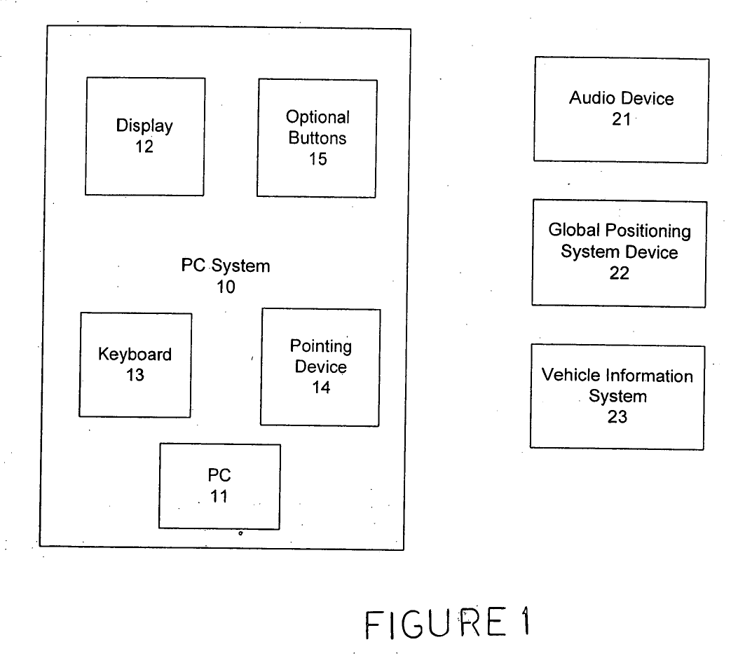

FIG. 1 shows peripheral components in the computer system 10. The components shown in FIG. 1 include an industry-standard PC 11, an electronic graphical display using LCD or VFD technology 12, an electronic keyboard 13 connected to the PC 11 through a cable or using infrared optical or radio wave technology, a pointing device 14 such as an optical mouse, and an optional physical array of electrical contact buttons 15.

In addition to the computer system 10, one or more additional devices (not shown) may be connected to the computer system 10 via electronic cable, such as an Ethernet network, RS-232 serial cable, or USB 1 or 2 cable, or via a radio signal produced and received by wireless networking devices, such as an 802.11b wireless network, or via infrared. Some additional examples of components include: an audio entertainment device 21, a global positioning system (GPS) receiver 22 and a vehicle information system interface 23.

The computer system 10 consists of a collection of three specially designed software modules that work together to provide the overall functionality. These modules each have unique and distinct functionality, and for the purposes of discussion hereafter will be referred to as the Executive module (EX), Third Party Software (TPS), and the Rule Management Program (RMP). The Executive module (EX) may be provided as a Windows executable program along with one or more statically or dynamically linked libraries. The Third Party Software (TPS) may be one or more commercially available Windows-compatible programs and the Rule Management Program (RMP) is either another distinct Windows-compatible program or implemented as part of the Executive module (EX). The TPS programs provide the functionality that is to be integrated and exposed through an alternative user interface as will be more fully described below.

The Executive module (EX) consists of sub-modules which are a Graphical User Interface (GUI), an Event, Status and Rules Processor (ESRP), and one or more sub-modules referred to as Third Party Software Adaptors (TPSA). The first sub-module of the EX is the GUI which consists of a display containing a first area and second area. The first area is reserved for display of information provided by the TPSA sub-modules. The second area consists of three or more icons, arranged in a linear manner, with the first icon indicating LEFT or PREVIOUS and the last icon. indicating RIGHT or NEXT. Between the first and last icons are one or more additional icons. Each icon between the first and last icons represents one of the TPSA sub-modules. Selection of the first or last icon causes the icons between the first and last to be exchanged for another collection of icons representing other TPSA sub-modules. Selection of an icon representing a TPSA sub-module will cause that TPSA sub-module to display its graphical user interface in the first area.

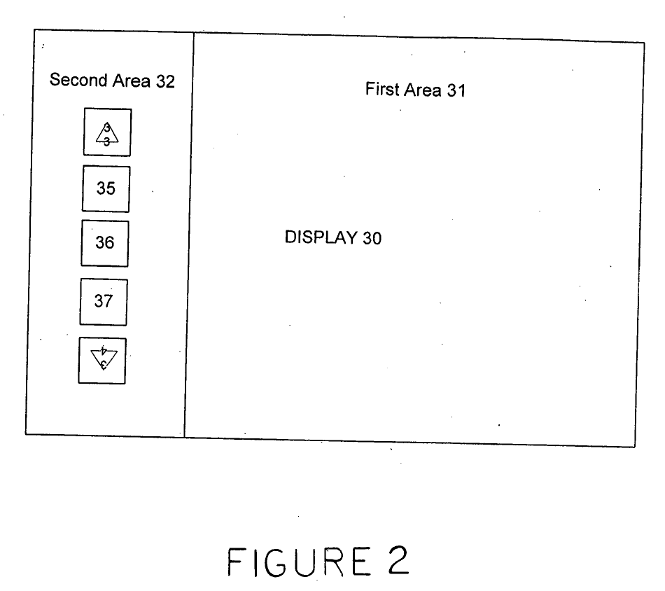

An example of this configuration is shown in FIG. 2 wherein the Graphical User Interface (GUI) consists of a display 30 containing a first area 31 and second area 32. The placement of the first area 31 and second area 32 is arbitrary, however for purpose of illustration only, the first area 31 is show as the right four-fifths of the available display area and the second area 32 is the remaining one-fifth. The first area 31 is reserved for display of information provided by the TPSA sub-modules, which consists of standard Microsoft Windows graphical user interface components, such as buttons, sliders and graphical images.

Referring once again to FIG. 2, the second area 103 consists of three or more icons, arranged vertically, with the top icon 33 indicating PREVIOUS and the bottom icon 34 indicating NEXT via triangular icons typically used for this purpose. Specific functionality for each of the TPSA sub-modules associated with the remaining icons is indicated by the nature of the icon. The icons of a speaker 35, compass 36 and gauge 37 are associated with the audio entertainment device 21, the global positioning system (GPS) receiver 22 and the vehicle information system interface 23, respectively.

In another embodiment the GUI may consist of a single display and a row of physical buttons (not shown). The display is reserved for presentation of information provided by the TPSA sub-modules. The buttons may or may not be located adjacent to the display, and consists of three or more buttons, arranged in a linear manner, with the first button indicating LEFT or PREVIOUS and the last button indicating RIGHT or NEXT. Between the first and last buttons are one or more additional buttons. Each button between the first and last buttons represents one of the TPSA sub-modules. The buttons are associated with the TPSA sub-modules by corresponding icons on the display, arranged in the same layout as the physical buttons. Selection of the first or last button causes the icons on the display to be exchanged for another collection of icons representing other TPSA sub-modules. Selection of a button representing a TPSA sub-module will cause that TPSA sub-module to display its graphical user interface on the single display.

The second sub-module of the EX module is the Event, Status and Rules Processor (ESRP) which provides for the monitoring of events generated by the GUI or one or more of the TPSA sub-modules, the maintenance of status information provided by the TPSA sub-modules, and the evaluation and processing of rules created by the Rule Management Program (RMP). Rules are based on events that occur during use of the computer system which are generated by the user through the GUI or by one or more of the TPS programs through the TPSA sub-modules. An event is defined as either an action initiated by the user (such as the depression of a button or contact with a touch screen) or a change in information maintained by one of the TPSA sub-modules. Each event has associated with it a unique identifier for that event.

Rules may be comprised of one or more parts and in one embodiment the method used comprises of five parts. The first part is a unique identifier for an event that has occurred that is made known to the system by either the GUI or one or more TPSA sub-modules. The second part is a unique identifier that identifies the source of the first part. The third part is a unique identifier for a TPSA sub-module associated with a TPS module. The fourth part is a unique identifier that indicates the action desired of the module associated with the third part. The fifth part is a unique identifier for a state or value to be associated with the action identified in the fourth part.

As events are generated, the ESRP compares the unique identifier associated with the event to the unique identifiers of the events to be monitored. If one or more matches are found, the ESRP sends the user-defined action and associated value indicated in each rule to the TPSA sub-module that has been identified in that particular rule.

The ESRP may also track the current status of each TPSA sub-module. Status information consists of a unique identifier representing an attribute of the TPSA sub-module's status and a value indicating the current status of that attribute. As each TPSA sub-module provides status information, the ESRP captures the information and maintains it for reference by other TPSA sub-modules to be used in response to events.

The third sub-module of the EX module consists of one or more TPSA sub-modules. The TPSA sub-module provides the linkage between the TPS and Executive. Events generated by the TPS are monitored by the TPSA sub-module associated with the TPS. The TPSA sub-module then determines if this event is to be made known. Each TPSA sub-module is designed to only make know “events of interest.” If the event is to be made known, it provides an event to the ESRP that is consistent with similar events from other combinations of TPS and TPSA sub-modules. The consistent event can then be identified and correctly identified and correctly interpreted by other TPSA sub-modules.

The TPSA sub-module is also capable of receiving actions and values associated with one or more rules from the ESRP. The TPSA sub-module then interprets the action and provides the required input to the TPS, taking into account the associated value, to cause the action to occur. This allows the TPSA sub-module to take a general action and value and provide the necessary specific action required to the TPS.

Finally, the TPSA sub-module provides a GUI interface. This GUI interface provides the information to the user generated by the TPS. However, the GUI interface provided by the TPSA sub-module provides consistent controls, labeling, layout and behavioral characteristics to other GUI interfaces provided by other TPSA sub-modules. The TPSA sub-module is designed to monitor the GUI of the TPS and provide translation and mapping of the information presented on the TPS GUI to the user through the TPSA sub-module GUI.

Lastly, the Rule Management Program (RMP) module provides a means for the user to create and persist rules for the system to implement. The rules are maintained in a specific order, assigned by the user, and the RMP provides the ability for the user to view, add, change, delete and reorder the rules.

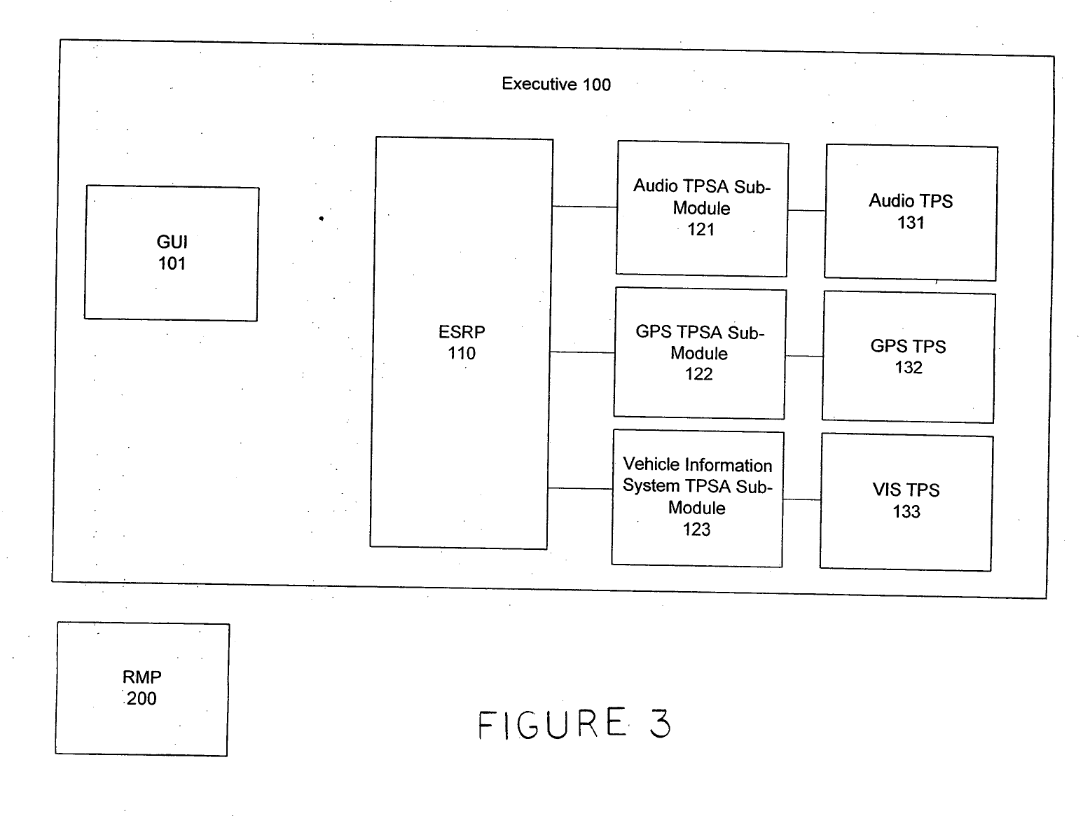

FIG. 3 diagrammatically shows the conceptual software modules within the system; the Executive module (EX) 100 is illustrated consisting of the GUI 101, the Event, Status and Rules Processor (ESRP) 110, three TPSA modules 121-123, and three Third Party Software programs 131-133. The Rules Management Program (RMP) 200 is indicated as a separate module, but may be included in the Executive module (EX). In the illustrated embodiment, the various modules are coded in the C++ programming language, however they may be coded in other languages, such as Microsoft Visual Basic or C#, Java or other programming languages.

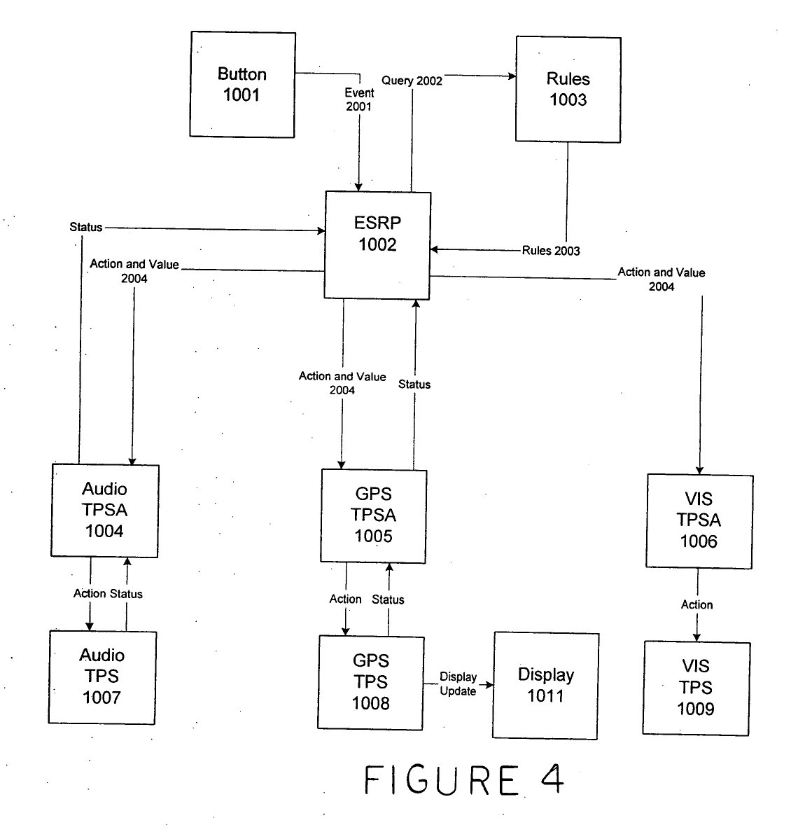

An example of the method for responding to an event is shown in FIG. 4. The particular event chosen for this illustration is the depression of a button 1001 indicating that the user wants to mute all audio output. Depressing the button causes an event 2001 to occur, which is passed on to the ESRP 1002. When the ESRP receives the event, it queries the current table of rules 1003 and extracts any rules 2003 for the indicated event. As the event was a request for audio mute, only the rules pertaining to requests for audio mute will be returned to the ESRP. The ESRP then passes on an action and value 2004 based on each of the rules associated with the audio mute event to each of the TPSA sub-modules 1004-1006. Each of the TPSA sub-modules then examines the action and value and determines if further processing is necessary. In this illustration, we will assume that the audio entertainment TPS 1007, the GPS TPS 1008, and the vehicle information system TPS 1009 require further processing.

In the case of the TPSA sub-module 1004 and the associated audio entertainment device TPS 1007, the TPSA sub-module performs whatever manipulations of the TPS GUI necessary to mute the audio output. Similarly, the TPSA sub-module 1005 and the associated GPS TPS 1008 also act to cause the audio output from the GPS TPS to be muted. In the case of the TPSA sub-module 1006 associated with the vehicle information system 1009, no action is taken by the TPSA sub-module as the vehicle information system TPS is not capable of producing audio output.

Resulting from the muting of the audio entertainment and GPS, the TPS programs 1007 and 1008 both experience changes to the GUI displays. The TPSA sub-modules 1004 and 1005 are both alerted to this change and send status update information to the ESRP. Further, for purpose of this illustration it should be understood that the GPS TPSA sub-module has been selected as the currently displayed module. The GPS TSAP sub-module will then update the display 1011 to reflect that the audio of the GPS has been muted.

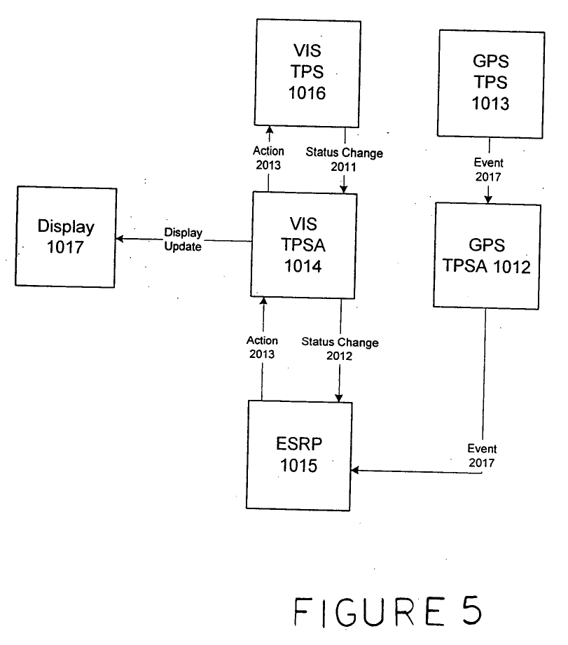

An example of the method for responding to status change is shown in FIG. 5. For the purpose of this illustration it should be understood that the vehicle information system TPS 1016 has indicated a status change and that the vehicle is now low on fuel. This status change 2011 is sent to the corresponding TPSA sub-module 1014. The TPSA sub-module responds by sending a change in status message 2012 to the ESRP 1015. The ESRP will then maintain this status information. The user then initiates an action to change the destination via the GPS TPSA 1012 and TPS 1013. This change in destination generates an event 2017 indicating the distance to the destination. When this event is received by the ESRP and compared to the rules an action 2013 is determined for the vehicle information system. This action causes the TPSA sub-module 1014, working with the vehicle information system TPS 1016, to calculate the fuel required to reach the destination, and if less than that remaining, cause the TPSA sub-module to update the display indicating insufficient fuel to reach the destination.

The method described may be embodied in other specific forms without departing from its spirit or essential characteristics. The described embodiments are considered in all respect only as illustrative and not restrictive. The scope of the method is, therefore, indicated by the appended claims, rather than by the foregoing description. All changes which come within the meaning and range of equivalency of the claims are to be embraced within their scope.

What is claimed is:

1. A method for integration of functionality of two or more computer programs comprising:
providing an executive executable program module having one or more statically or dynamically linked libraries for integrating one or more third party software modules each having predefined user interfaces;
allowing controls and displays of said user interfaces normally presented by each said third party software module to be hidden from a user and an alternative, consistent presentation of those controls and displays to be presented to the user by integrating and exposing said one or more third party software modules through an alternative graphical user interface; and
implementing a rule management program wherein each said third party software modules ability to interact is based on allowing for modeling of rules to enact events based on user preferences using said rules management program wherein said rules used to indicate actions taken by said third party software modules are initiated with or without user intervention thereby causing said one or more third party software modules to appear to function as a single unified program by sharing of data and initiating functionality through direct manipulation of their user interfaces by said executive executable program module.

2. The method for integration of functionality according to claim 1 wherein said executive executable program module further comprises:
one or more third party software adaptors each having a graphical user interface;
an executive graphical user interface for displaying a first area and a second area; and
said first area for displaying information provided by one or more third party software adaptors with said second area representing each said one or more third party software adaptors by using identifying icons wherein selection of an icon representing a third party software adaptor causes said third party software adaptor to display its graphical user interface in said first area.

3. The method for integration of functionality according to claim 2 wherein said executive executable program module further comprises:
an event, status and rules processor for monitoring events generated by said executive graphical user interface and said one or more third party software adaptors wherein said event, status and rules processor maintains status information provided by said one or more third party software adaptors.

4. The method for integration of functionality according to claim 3 wherein said rule management program further comprises:
generating rules based on events that occur during use of said executive executable program module which are generated by an action initiated by the user through the graphical user interface or by said one or more third party software modules through a change in information maintained by said one or more third party software adaptors wherein each event has associated with it a unique identifier for that event.

5. The method for integration of functionality according to claim 4 wherein generating rules for events further comprises:
generating a first unique identifier part for an event that has occurred that is made known to said executive executable program module by either said graphical user interface or one or more third party software adaptors;
generating a second unique identifier that identifies a source of said first unique identifier part;
generating a third unique identifier part for a third party software adaptor associated with a third party software module;
generating a fourth a unique identifier part that indicates an action desired by said third party software module associated with said third unique identifier part; and
generating a fifth unique identifier part for a state or value to be associated with said action identified in said fourth unique identifier part.

6. The method for integration of functionality according to claim 5 wherein said event, status and rules processor further comprises:
comparing said unique identifier parts associated with an event to said unique identifier parts of said events to be monitored when events are generated and if one or more matches are found, said event, status and rules processor sends a user-defined action and associated value indicated in each rule to said third party software adaptor that has been identified in that particular rule wherein said event, status and rules processor tracks current status of each third party software adaptor capturing information and maintaining it for reference by other third party software adaptors to be used in response to events

7. A system of two or more computer programs comprising:
means for providing an executive executable program module having one or more statically or dynamically linked libraries for integrating one or more third party software modules each having predefined user interfaces;
means for allowing controls and displays of said user interfaces normally presented by each said third party software module to be hidden from a user and an alternative, consistent presentation of those controls and displays to be presented to the user by integrating and exposing said one or more third party software modules through an alternative graphical user interface; and
means for implementing a rule management program wherein each said third party software modules ability to interact is based on allowing for modeling of rules to enact events based on user preferences using said rules management program wherein said rules used to indicate actions taken by said third party software modules are initiated with or without user intervention thereby causing said one or more third party software modules to appear to function as a single unified program by sharing of data and initiating functionality through direct manipulation of their user interfaces by said executive executable program module.

8. The system according to claim 7 wherein said executive executable program module further comprises:
means for interfacing one or more third party software adaptors each having a graphical user interface;
means for displaying an executive graphical user interface for a first area and a second area; and
means for displaying said first area information provided by one or more third party software adaptors with said second area representing each said one or more third party software adaptors by using identifying icons wherein selection of an icon representing a third party software adaptor causes said third party software adaptor to display its graphical user interface in said first area.

9. The system according to claim 8 wherein said executive executable program module further comprises:
means for generating an event, status and rules processor for monitoring events by said executive graphical user interface and said one or more third party software adaptors wherein said event, status and rules processor maintains status information provided by said one or more third party software adaptors.

10. The system according to claim 9 wherein said rule management program further comprises:
means for generating rules based on events that occur during use of said executive executable program module which are generated by an action initiated by the user through the graphical user interface or by said one or more third party software modules through a change in information maintained by said one or more third party software adaptors wherein each event has associated with it a unique identifier for that event.

11. The system according to claim 10 wherein generating rules for events further comprises:
means for generating a first unique identifier part for an event that has occurred that is made known to said executive executable program module by either said graphical user interface or one or more third party software adaptors;
means for generating a second unique identifier that identifies a source of said first unique identifier part;
means for generating a third unique identifier part for a third party software adaptor associated with a third party software module;
means for generating a fourth a unique identifier part that indicates an action desired by said third party software module associated with said third unique identifier part; and
means for generating a fifth unique identifier part for a state or value to be associated with said action identified in said fourth unique identifier part.

12. The method for integration of functionality according to claim 10 wherein said event, status and rules processor further comprises:
means for comparing said unique identifier parts associated with an event to said unique identifier parts of said events to be monitored when events are generated and if one or more matches are found, said event, status and rules processor sends a user-defined action and associated value indicated in each rule to said third party software adaptor that has been identified in that particular rule wherein said event, status and rules processor tracks current status of each third party software adaptor capturing information and maintaining it for reference by other third party software adaptors to be used in response to events
